(19) United States
(12) Patent Application Publication
(10) Pub. No.: US 2022/0402232 A1
(43) Pub. Date: Dec. 22, 2022

(54) SHAFT FOR ATHLETIC ACTIVITIES

(71) Applicant: PDA ECOLAB, SAS, Meylan (FR)

(72) Inventor: Lance JOHNSON, Meylan (FR)

(21) Appl. No.: 17/778,247

(22) PCT Filed: Nov. 19, 2020
(86) PCT No.: PCT/IB2020/000960

§ 371 Date: May 19, 2022

Related U.S. Application Data
(60) Provisional application No. 62/937,274, filed on Nov. 19, 2019.

(51) Int. Cl. B32B 1/08; A63B 53/10; B32B 5/02; B32B 5/26; B32B 37/18; B32B 38/08; B32B 38/18; B32B 38/00; B29C 70/30; A45B 9/00

(52) U.S. Cl. CPC B32B 1/08; A63B 53/10; B32B 5/02; B32B 5/26; B32B 37/18; B32B 38/08; B32B 38/1808; B32B 38/0012; B29C 70/30; A45B 9/00; A63B 2209/023; B32B 2262/065; B32B 2260/023; B32B 2260/046; B32B 2250/20; B32B 2305/076; B32B 2038/0076; B32B 2597/00; B32B 2262/062; B32B 2317/18; B32B 2317/10; B29K 2201/00

(57) ABSTRACT

The present disclosure relates to a shaft for athletic activities comprising, along at least a part of the length of the shaft: an internal wall (31) made of a first fiber-reinforced composite; and an external wall (30), fixed to the internal wall, and made of a second fiber-reinforced composite, wherein one or more cavities (32A, 32B, 32C) are present between the internal wall and the external wall.

The present patent application claims priority from the US patent application filed on 19 Nov. 2019 and assigned application No. U.S. 62/937,274, the contents of which is hereby incorporated by reference.

### TECHNICAL FIELD

The present disclosure relates generally to a shaft or pole and more particularly to a shaft for athletic activities, such as a ski pole, hiking pole, trekking pole, shaft for a kayak paddle or a rowing paddle, etc.

### BACKGROUND ART

Millions of athletes utilize one or more stabilization poles, often referred to as trekking, hiking or ski poles, in outdoors and sporting activities. Typical construction utilizes an aluminum alloy, fiberglass, carbon fiber or a combination of these materials, to create the main body or shaft of the pole.

Other athletic equipment designed to provide propulsion either to a user or an object (e.g. a ball or puck) including but not limited to the shaft separating the two paddling blades of a kayak paddle, the boom of a wind surfing sail, the shaft of a hockey, a floorball or lacrosse stick, or the shaft of a golf club also use similar materials and construction techniques in order to resist similar stresses which the shaft is subjected to during use.

The use of a composite construction for the shaft, in which reinforcement fabrics or fibers are captured within a resin matrix, provides a greater ability to create a pole with both stiffness (or flexibility) and weight characteristics that are unachievable with an alloy shaft. Indeed, materials such as carbon fibers can have many-times the stiffness and/or strength by weight of aluminum alloy.

With increasing global demand for reducing consumption of non-renewable resources and extracted raw materials, such as petroleum-based carbon fiber, there is a demand to replace synthetic fibers of the reinforcement fabrics used in composites, such as carbon fibers, fiberglass, Kevlar, boron, etc., with renewable fibers. The difficulty in making this transition lies in the inherent difference of mechanical characteristics exhibited by these natural fibers and their synthetic counterparts.

### SUMMARY OF INVENTION

Embodiment of the present disclosure address all or some of the drawbacks of known shafts for athletic activities.

One embodiment provides a shaft for athletic activities comprising, along at least a part of the length of the shaft:
an internal wall made of a first fiber-reinforced composite; and
an external wall, fixed to the internal wall, and made of a second fiber-reinforced composite, wherein one or more cavities are present between the internal wall and the external wall,
for example, the shaft is a ski pole shaft, a trekking pole shaft, a golf club shaft, a floorball stick shaft, a hockey stick shaft, a broomball stick shaft, a oar shaft or a paddle shaft.

According to an embodiment, there are at least three cavities between the internal wall and the external wall.

According to an embodiment, at least one portion of the fibers of the first and/or second fiber-reinforced composite are natural fibers.

According to an embodiment, the fibers of the first and/or second fiber-reinforced composite are vegetal-based fibers including those of bamboo, flax, ramie, pineapple leaf and/or extracted cellulose or nanocellulose.

According to an embodiment, the first and second composites each have a weight percentage of resin of between 20% and 60%, for example of between 35% and 45%.

According to an embodiment, the first and/or second composite is a fabric-reinforced composite.

According to an embodiment, the internal wall and/or the external wall are filament wound plies.

According to an embodiment, at least one of the first and/or second composites comprises a fabric, a filament-wound ply, or braid having fibers at an orientation angle of between 30° and 60°, and/or of between −30° and −60°, with respect to an axis of the shaft.

According to an embodiment, at least one of the first and second composites comprises a fabric, tape or filament-wound ply, having fibers at an orientation angle of between −15° and 15° with respect to an axis of the shaft.

According to an embodiment, the external wall is round, or substantially round, in cross-section.

According to an embodiment, the internal wall is tubular.

According to an embodiment, the internal wall comprises a plurality of planar wall portions, linked for example by curved corners.

According to an embodiment, fibers of the external wall are orientated in one or more first directions with respect to an axis of the shaft, and fibers of the internal wall are orientated in one or more second directions, different to the first directions, with respect to the axis of the shaft.

One embodiment provides a method of manufacturing a shaft, the method comprising:
covering a mandrel or inflatable bladder with at least one first ply, wherein the at least one first ply is impregnated with a first resin;
fixing at least one spacer element to an outer surface of the at least one first ply to form a structure having one or more exposed regions in its outer surface;
covering the structure with at least one second ply, wherein the at least one second ply is impregnated with a second resin;
curing to cause the at least one first ply and the first resin to form an internal wall of a first fiber-reinforced composite and the at least one second ply and the second resin to form an external wall of a second fiber-reinforced composite; and
removing the at least one spacer element to create one or more cavities between the internal wall and the external wall.

According to an embodiment, the outer surface of the structure is round, or substantially round, in cross-section, and covering the structure with at least one second ply involves the use of roll-wrapping.

The solution presented herein involves making natural fiber reinforcement competitive with synthetic fiber reinforcement by utilizing a unique geometry for the construction of the natural fiber shaft, where each fiber reinforcement is used more-efficiently than is standard practice for current synthetic fibers poles.

One embodiment provides a molded, fiber-reinforced composite shaft having a significantly-tubular shape, which may incorporate one or more tapers over its length, with, for example, a maximum outer dimension of 30 mm and a minimum outer dimension of 8 mm. The structure of the shaft incorporates plies of reinforcing fiber fabric, which are oriented variously to resist the forces exerted during use of the shaft, and which are captured within a resin matrix.

One embodiment provides the utilization of spacer elements in the process of fabrication of the shaft in the form of solid, removeable elements, which may be variably affixed to the mandrel/mold. The purpose of the spacer elements is to create a final structure which is more complex and more rigid than a standard solid-wall shaft at a given weight utilizing the same materials. As such, it is also possible to use a material with lesser mechanical characteristics to achieve a similar rigidity at a similar weight, depending on the ratios of weight to mechanical characteristic of the two materials.

One embodiment provides the fabrication of the shaft by various combinations of fabric reinforcement plies impregnated with resin and spacer elements around a rigid or flexible mandrel, or an expanding bladder. Plies may be added by roll-wrapping, hand-layup, filament winding, or any other method typical to composite layup assembly.

One embodiment provides an external compression to a rigid mandrel, or situating the completed layup and expanding bladder or flexible mandrel inside a rigid outer form, and a step to cure the resin component of the composite with time and heat exchange in order to create the rigid form of the shaft.

The significantly tubular shape of the shaft may incorporate shaping such as a rounded-triangular, rounded-square, or other shape or shapes around the vertical axis of the shaft.

The shaft may include tapers, bends, and other features along its vertical axis.

Plies of reinforcement fabric may be composed of carbon fiber, fiberglass, Aramid/Kevlar, Twaron, boron, Zyex, Spectra/Dyneema; natural fiber such as Bast Fiber (ie. flax, ramie, hemp), Leaf Fiber (i.e. Pineapple, Banana, Sisal), Stalk Fiber (i.e. rice, corn, wheat), Seed Fiber (ie. kapok, cotton), or Grass Fiber (i.e. bamboo); Titanal, titanium, or steel mesh; other natural or synthetic vibration-damping materials such as elastomer or cork; or other such fibers or materials that provide advantageous characteristics to the structure.

The reinforcing fabric may be constructed of fibers in a braided, woven, knit, stitched, or uni-directional arrangement.

The resin may be a thermoset or thermoform resin, and may be added to the fabric through: pre-pegging, i.e. impregnating the fabric with a combination of wet and/or dry resins at or around the time the fabric is produced; wet layup, i.e. introducing a wet resin to the fabrics in close proximity to when the fabrics are utilized for construction of the shaft; or an infusion process, i.e. where resin is introduced to the fabric once the layup is placed in a contained mold or compression system.

A composite of an internal wall of the pole can be constituted of tubular braid, or any construction of reinforcement fabric.

The length of the pole may be segmented into multiple sections to create a telescopic or folding pole.

The process of situating the reinforcement fabric for the shaft fabrication can be hand-lay-up, roll wrapping, filament winding, or any other process typical to the fabrication of fiber-reinforced composite items.

A rigid mandrel may have any form that is advantageous to the construction of the correct internal geometry of the shaft.

The spacer elements may be affixed to the mandrel, or held in position by a combination of the mandrel geometry and the layup, or in such a manner that they are not rigidly held in place and are captured only by the layup.

The spacer elements may extend the full length of the shaft, or be limited to a portion of the length of the shaft, or any segment of the shaft when utilized to form multi-segment shafts.

One or more spacer elements may be used to create a cross-section that is significantly round or which is more-lobular in shape.

One or more spacer elements may be added between multiple plies to strengthen the structure as needed.

The spacer elements may be constructed of steel, aluminum, or other metals or materials that, for example, possess appropriate stiffness and/or dimensional stability to function in the layup and curing processes.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1A is a side view of a ski pole according to an example embodiment;

FIG. 1B is a side view of a ski pole according to a further example embodiment;

FIG. 2A is a side view of a golf club according to an example embodiment;

FIG. 2B is a side view of an oar for athletic water activities according to an example embodiment;

FIG. 3 shows a cross-section view of a shaft for athletic activities according to an example embodiment of the present disclosure;

FIGS. 4 and 5 each show, by a cross-section view and a side view, steps of a method of manufacturing the shaft illustrated in FIG. 3;

FIG. 6 illustrates a tubular braid;

FIGS. 7 and 8 each show, by a cross-section view and a side view, further steps of a method of manufacturing the shaft illustrated in FIG. 3;

FIGS. 9 and 10 are cross-section views illustrating further steps of a method of manufacturing the shaft illustrated in FIG. 3;

FIG. 11 shows a cross-section view of a shaft for athletic activities according to another example embodiment of the present disclosure;

FIGS. 12 to 15 are cross-section views illustrating steps of a method of manufacturing the shaft illustrated in FIG. 11;

FIG. 16 shows a cross-section view of a shaft for athletic activities according to another example embodiment of the present disclosure; and

FIGS. 17 to 22 are cross-section views illustrating steps of a method of manufacturing the shaft illustrated in FIG. 16.

### DESCRIPTION OF EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the vertical orientation of a shaft.

Unless specified otherwise, the expressions “around”, “approximately”, “substantially” and “in the order of” signify within 10%, and preferably within 5%.

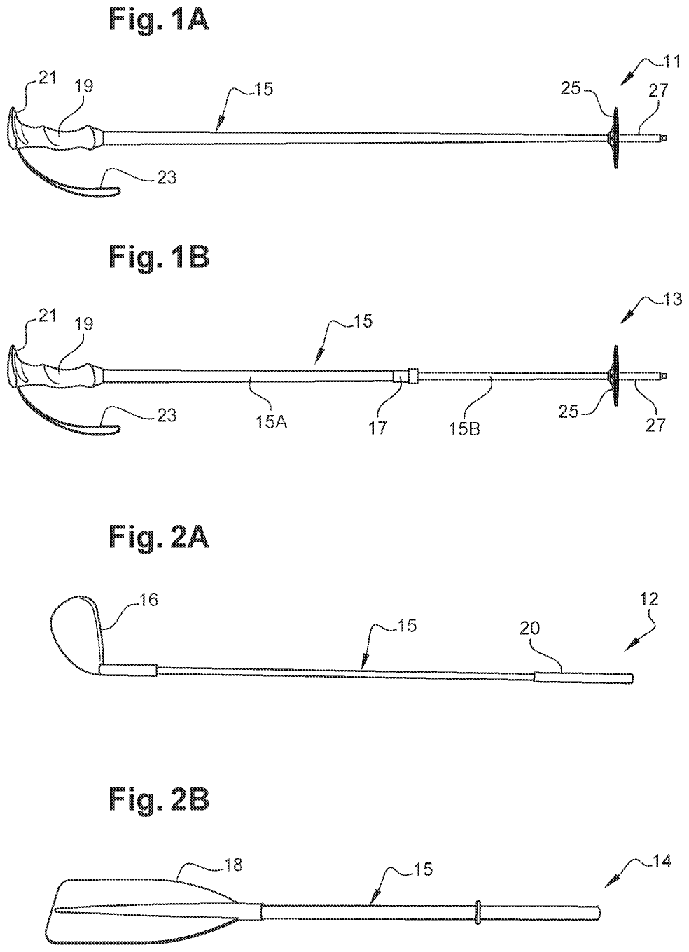

FIG. 1A is a side view illustrating an example of a ski pole 11.

It will be apparent to those skilled in the art that the principles described herein can be applied to other types of shaft for athletic activity, for example, hiking or trekking poles, the shaft of a kayak paddle or of a rowing oar, the mast of a windsurfing rig, etc. For example, depending on the application, the pole is used for stabilizing and/or propelling a user of the pole.

The ski pole 11 of FIG. 1A comprises a shaft 15 having, at its upper end, a grip formed of a body 19 and a head 21, and a hand strap 23. At the lower end of the shaft, there is a basket 25 and a tip 27 of the pole.

In the embodiment of FIG. 1A, the shaft 15 of the ski pole 11 is in one part, and the grip is, for example, positioned around and on the shaft 15. The grip is, for example, made of rubber, plastic, or a composite material. The body 19 of the grip has, for example, a shape adapted to sitting comfortably between the palm and fingers of the left or right hand of a user. Indeed, the pole 11 is for example interchangeable between the left and right hands of a user.

In one embodiment, the basket 25 is located a few centimeters from the lower end of the pole. The basket 25 is, for example, located around the shaft 15 and shaped like a disc. The basket 25 is made of plastic or a composite material and has, for example, some apertures. The tip 27 is the portion of the pole 11 positioned below the basket 25. In some embodiments, the tip 27 is formed from the same piece as the basket 25, while in other embodiments it is formed by a separate piece to which the basket 25 is fixed to the tip 27, for example by a threaded joint. The bottom end of the pole may exhibit a variety of constructions and attachment methods for the basket 25 and the tip 27, listed examples being illustrative but not exhaustive.

FIG. 1B is a side view illustrating a ski pole 13 according to an alternative example to that of FIG. 1A.

The pole 13 illustrated in FIG. 1B is similar to the pole 11 illustrated in FIG. 1A, except that the pole 13 illustrated in FIG. 1B is a telescopic ski pole having its shaft 15 formed of two parts 15A and 15B.

In the embodiment of FIG. 1B, one of the parts of the shaft 15 is arranged to slide into the other. For example, the lower part 15B of the shaft 15 closest to the tip 27 is arranged to slide into the part 15A of the shaft 15 closest to the grip.

The pole 13 illustrated in FIG. 1B comprises a locking adjuster 17, which is used to block the position of one part of the shaft 15 with respect to the other. The locking adjuster 17 thus enables the length of the pole 13 to be adjusted.

In alternative embodiments, the shaft 15 of the ski pole 13 could have more than two parts. The ski pole 13 can then have more than one locking adjuster 17. Furthermore, rather than being telescopic, the portions of the shaft 15 could be joined by other means, for example by hinges and locking mechanisms, thereby allowing the pole to be foldable.

FIG. 2A is a side view of a golf club 12 according to an example embodiment.

The golf club 12 of FIG. 2A comprises a shaft 15 having, at its upper end, a grip 20. At the lower end of the shaft 15, there is a club head 16.

FIG. 2B is a side view of an oar 14 for athletic water activities according to an example embodiment.

The oar 14 of FIG. 2B comprises a shaft 15 having, at its lower end a blade 18.

It is known to fabricate poles such as the ones of FIG. 1A to 2B using fiber-reinforced composites to form the shaft 15. As will be described in more detail below, according to the embodiments described herein, it is possible to, at least partially, replace synthetic fibers with natural fibers. A difficulty in doing so is that, while the density or specific gravity of most natural fibers is lower than synthetic fibers, which is an advantage in improving the strength-to-weight ratio, the tensile strength and Youngs Modulus of natural fibers typically offer a reduced level of performance when compared to synthetic fibers. As an example, the standard synthetic fibers may have a specific gravity of 1.8 and a Youngs Modulus of 30 000 MPa, whereas the strongest natural fibers may have a specific gravity of 1.4 and a Youngs Modulus of 10 000 MPa. This creates a comparative specific modulus of 16 667 for synthetic fiber and of 7 143 for natural fibers, meaning twice the weight of natural fiber would be needed to achieve the same stiffness. However, the present inventor has found that such a weight increase can be avoided by providing a particular internal structure of the pole, as will now be described in more detail.

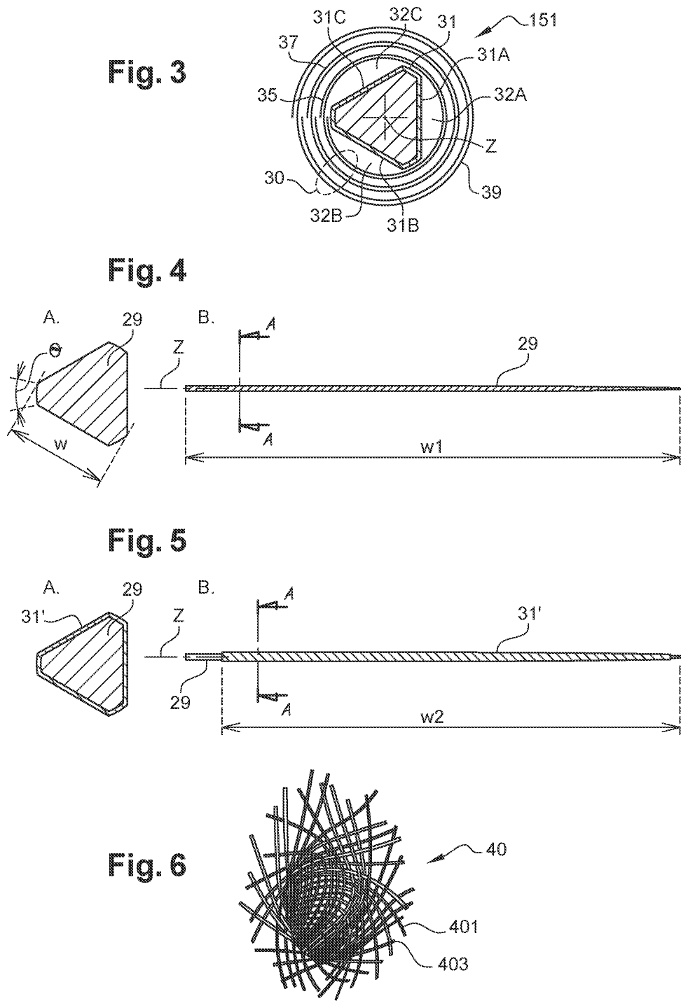

FIG. 3 is a cross-section view of a shaft 151, and corresponds for example to a cross-section of: at least a portion of the shaft 15 of the pole 11 of FIG. 1A; or of at least a portion of the lower part 15B of the shaft 15 of the pole 13 of FIG. 1B, between the locking adjuster 17 and the tip 27; or at least a portion of the upper part 15A of the shaft 15 of FIG. 1B, between the locking adjuster 17 and the grip. Moreover, FIG. 3 can correspond to a cross-section of the shaft 15 of the golf club 12 of FIG. 2A, or the shaft 15 of the oar 14 of FIG. 2B.

In the case that the shaft 151 is a shaft of the ski pole 11 or 13 of FIG. 1A or 1B, it for example has an outer dimension of between 8 mm and 30 mm, depending on where the cross-section is taken. More generally, the diameter of the shaft 151 is for example of between 5 mm and 100 mm, depending on the application.

The shaft 151 shown in FIG. 3 comprises, along at least a part of the length of the shaft:
an internal wall 31 made of a fiber-reinforced composite;
an external wall 30, fixed to the internal wall 31, and made of a fiber-reinforced composite, which may be of the same or of a different type to the composite of the internal wall 31; and
one or more cavities 32A, 32B and 32C present between the internal wall 31 and the external wall 30.

Each of the internal and external walls 31, 30, for example comprises one or more plies formed of a fabric or of fibers held within a resin matrix.

In the example of FIG. 3, the internal wall 31 comprises a single ply, and the external wall 30 of the shaft 151 comprises three plies, of which an inner ply 35 contacts the internal wall 31, an external ply 39 forms an outer layer of the shaft, and a ply 37 is between the plies 35 and 39. Each of these plies 35, 37 and 39 is for example double-wrapped, although in alternative embodiments, a different number of wraps would be possible.

In some embodiments, the cavities 32A, 32B and 32C do not extend the full length of the shaft 15. For example, a portion of the shaft 15 of the pole 11 closest to the tip end, or at least a portion of the bottom part 15B, or the upper part 15A of the shaft 15 of the pole 13, has a cross-section view similar to the cross-view illustrated in FIG. 3, but without any cavities 32A, 32B and 32C.

In one embodiment, the internal wall 31 is tubular, implying that, in cross-section, it forms a continuous wall. Furthermore, the internal wall 31 for example comprises a plurality of planar wall portions linked, for example, by curved corners that make contact with the inner surface of the external wall 30. For example, the internal wall 31 of the shaft 151 consists of three planar wall portions 31A, 31B and 31C linked by three curved corners. Furthermore, in one example, the three planar wall portions are orientated at between 40° and 100° with respect to each other, in order to form a tube that in cross-section has substantially the shape of a triangle with rounded corners. Each of the rounded corners for example has a curvature that matches the curvature of the inner surface of the external wall 30. An angled θ occupied by each curved corner is for example between 5° and 60° in the example of FIG. 3. With the rounded corners, the internal wall 31 for example has a substantially hexagonal shape.

In one embodiment, the internal wall 31 has, in cross-section, one of a rounded equilateral triangle shape, a rounded isosceles triangle shape, a rounded-square shape, a rounded-pentagonal shape, a rounded-hexagonal shape, a rounded-heptagonal shape, or a rounded-octagonal shape. The shape of the internal wall 31 is not limited to the cited shapes and the internal wall 31 can have any other shape. For example, the internal wall 31 could alternatively have an octagonal shape, a circular shape, a triangular shape, a decagonal shape, a dodecagonal shape or any shape that can be inscribed within a circle, and which is advantageous to the desired mechanical characteristics, dimensions, and flex pattern desired for the shaft.

In the cross-section view of FIG. 3, the plies 35, 37 and 39 have a circular shape, although in alternative embodiments different shapes that are substantially circular, such as an ellipse, rounded square, hexagon or stadium shape, would also be possible. However, the shape of the plies 35, 37 and 39 is not limited to those shape and other desires shape would also be possible.

The fibers of the fiber- or fabric-reinforced composites of the internal and external walls 31, 30 are for example, carbon fibers, glass fibers, aramid fibers, such as fibers known under the brand names Kevlar and Twaron, boron fibers, fibers known under the brand names of zyex, spectra or dyneema, basalt fibers, bast fibers, such as flax fibers ramie fibers or hemp fibers, or other natural fibers such as Leaf Fiber (i.e. Pineapple, Banana, Sisal), Stalk Fiber (i.e. rice, corn, wheat), Seed Fiber (i.e. kapok, cotton), or Grass Fiber (ie. bamboo), or other natural or synthetic vibration-damping material fibers such as elastomers fibers or cork fibers. In some embodiments, the natural fibers are vegetal or vegetal-derived fibers including extracted cellulose or nanocellulose. In some embodiments, the internal or external wall 31, 30 may further comprise a metal mesh, such as a Titanal mesh, titanium mesh or steel mesh.

In some embodiments, the fibers of the internal wall 31, and the fibers of each of the plies 35, 37 and 39 of the external wall 30, are all different from each other, whereas in other embodiments, there are at least two different types of fibers among the plies of the internal and external walls 31, 30. In one embodiment all the plies and reinforcements comprising the shaft 151 are produced from the same types of fibers, and the plies are then only different in terms of fabric construction or orientation.

In one embodiment, the fibers of the internal wall 31, and/or of at least one of the plies 35, 37 and 39, are natural fibers, such as organic fibers, or vegetal or vegetal-derived fibers. For example, the fibers of the internal wall 31 and of each of the plies 35 and 37 are bamboo fibers, while the fibers of the ply 39 are, for example, ramie fibers.

The resins of the fiber- or fabric-reinforced composites of the internal and external walls 31, 30 are, for example, thermosets resins or/and thermoforms resins. In some embodiments the same resin is used in each of the walls 31, 30, whereas in alternative embodiments, there are at least two different types of resin.

In one embodiment, the fiber-reinforced composite of the internal and external walls 31, 30 is composed of between 20% w (weight percent) to 60% w of resin, for example, between 35% w to 45% w of resin.

In some embodiments, the fibers of the internal wall 31 and of each of the plies 35, 37, 39 of the external wall 30 are in the form of a fabric, such as a braid, or a woven, knitted, meshed or stitched fabric. The fibers in the fabric are for example orientated in a multi-directional, bi-directional or uni-directional arrangement. For example, the fibers are prepared in the form of a thread, or in the form of uni-directional strips, and the threads and/or strips are woven, stitched or otherwise assembled in a multi-directional, bi-directional or uni-directional arrangement in order to form a multidirectional, bi-directional or uni-directional fabric respectively.

In one embodiment, in order to provide a relatively high bending strength of the shaft 151, the fabric of at least one of the plies of the walls 30, 31 comprises a uni-directional fabric oriented substantially in line with the Z axis of the shaft, and for example at around an angle of between −5° and +5° with respect to that axis, and the fabric of at least one other ply of the walls 30, 31 comprises a multi-directional fabric, and/or a bi-directional fabric having fibers in a first direction oriented with an angle of between 30° and 60°, and in some cases between 40° and 50°, with respect the axis Z, and having fibers in a second direction oriented with an angle of between −30° to −60°, and in some cases between −40° and −50°, with respect the axis Z.

In one example, a ply of the internal wall 31 is a tubular braid, the ply 35 is a woven bi-directional fabric, the ply 37 is a uni-directional fabric, and/or the ply 39 is a stitched bi-directional fabric.

In one embodiment, at least two plies of the shaft 151 have fibers oriented in different directions to each other with respect to the axis of the shaft.

A method of manufacturing the shaft 151 of FIG. 3 will now be described with reference to FIGS. 4 to 10.

FIG. 4 illustrates, with a cross-section view A and a side view B, a mandrel 29 used in the method. The view A is a cross-section view taken along a cutting line AA shown in the view B.

The outer surface of the mandrel 29 is, for example, shaped in accordance with the shape of the internal wall 31 of the shaft that is to be formed.

In the example of FIG. 4, the mandrel 29 comprises a plurality of planar sides linked, for example, by curved corners. For example, the mandrel 29 consists of three planar sides linked by three curved corners.

For example, the mandrel 29 has, in the cross-section view of FIG. 4 (view A), a rounded hexagonal shape. In another embodiment, the mandrel 29 can have an octagonal shape, a circular shape, a triangular shape, a decagonal shape, a dodecagonal shape or any other shape that can be inscribed in a circle and is suitable for forming the internal wall 31 of the shaft.

In the embodiment of FIG. 4, the mandrel 29 has a length w1 in the range from 60 cm to 200 cm, although this length will depend on the length of the shaft that is to be formed.

In the embodiment of FIG. 4, the mandrel 29 has cross-sectional dimensions that vary along its length, such that there is for example a difference in its diameter between one end and the other. The mandrel 29 has, for example, a gradual taper from one end to the other. For example, the mandrel has, at the upper end or handle end, which is the left-hand end in the view B of FIG. 4, a width w at its widest point of between 10 mm and 20 mm, and for example of around 15 mm, and, at the lower end or tip end, which is the right-hand end in the view B of FIG. 4, a width w at its widest point of between 8 mm and 3 mm, and for example of around 4 mm.

The mandrel 29 is for example solid, and is made of steel, aluminum or another rigid or flexible material such as silicone, elastomeric polymer, acrylonitrile butadiene styrene (ABS), or polyamide.

In the present description, a central axis of the mandrel 29 running along its length will be called axis Z, like the axis of the shaft.

FIG. 5 illustrates, with a cross-section view A and a side view B, the mandrel 29 after application of a ply 31′ for forming the internal wall 31. The cross-section of view A is taken along the cutting line AA of the view B.

In the embodiment of FIG. 5, the ply 31′ covers the mandrel 29 around its lateral circumference. For example, the ply 31′ is a tubular-braid that is formed separately and then pulled over the mandrel 29, or a tubular wrapping that is directly formed around the mandrel using a filament winding process to mimic the structure of the tubular braid, such a process being known to those skilled in the art.

In the embodiment illustrated in FIG. 5, the ply 31′ has a length w2 shorter than the length w1 of the mandrel 29, a portion of the mandrel of between 2 and 20 cm in length for example remaining exposed at each of its ends, thereby facilitating the manipulation of the mandrel 29 during subsequent processes, and the fixing of spacers as will be described below.

FIG. 6 illustrates an example of a tubular braid 40. The braid 40 is for example formed of many fiber tows, for example between 20 and several hundred, that are braided to form a tubular shape by a tubular braiding loom. All of the tows used to form the braid may be of a same type of fiber, or two or more different fiber types can be mixed in order to obtain certain desired properties, such as shock damping or high tensile strength.

In some embodiments, the tows of the tubular braid are formed in two different orientations with respect to the axis of the braid, certain tows 401 being formed at a first orientation, and certain tows 403 being formed at another different orientations, one example of each of these tows being labelled in FIG. 6.

Once the braid is situated and tightly drawn around the mandrel 29, in view of the variation in the diameter of the mandrel from one end to the other, the orientations of the tows of the braid with respect to the axis Z of the mandrel for example varies along the length of the mandrel. In particular, as the upper end of the mandrel 29 is wider than the lower end, the angle between the tows 401 and the axis Z, and the angle between the tows 403 and the axis Z, are not the same at the upper end and at the lower end. At the upper end, the tows 401, and thus also the fibers within the tows 401, are for example oriented with an angle of between 30° and 60°, and for example of between 40° and 50°, with respect to the axis Z, and the tows 403, and thus also the fibers within the tows 403, are for example oriented with an angle of between −30° and −60°, and for example of between −40° and −50°, with respect to the axis Z. At the lower end, the braid is tighter and thus narrower than at the upper end, such that the braid is in contact with the shaft 151. Thus, at the lower end, the fibers are for example oriented at a lower angle with respect to the axis Z, the tows 401 for example being orientated at an angle of between 10° and 40° with respect to the axis Z, and the tows 403 for example being orientated at an angle of between −10° and −40° with respect to the axis Z.

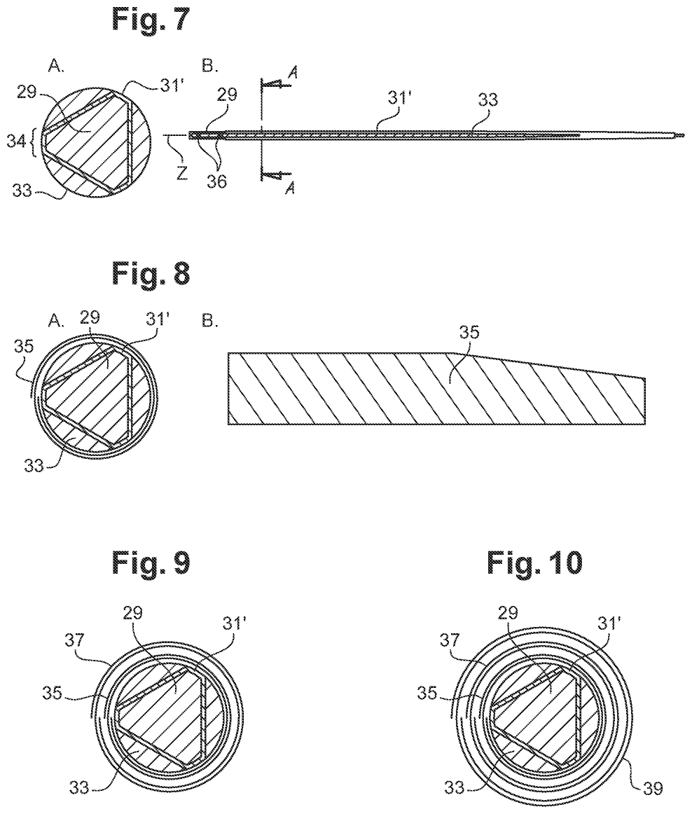

FIG. 7 illustrates, with a cross-section view A and a side view B, a structure composed of the mandrel 29, the ply 31′, and spacer elements 33 positioned on an outer surface of the ply 31′. The cross-section of view A is taken along the cutting line AA of the view B.

The spacer elements 33 are used to form the cavities 32A, 32B and 32C between the internal wall 31 and the external wall 39 of finished shaft. In some embodiments, an inner surface of the external wall 39 of the finished shaft is to be round, and the spacer elements 33 are formed around the outer surface of the structure so that the cross-section view of the structure shown in FIG. 7 is significantly round. Thus, the spacer elements 33 are for example positioned on the planar exterior surfaces of the ply 31′, and in cross-section, the spacer elements are shaped as segments of a circle, with their flat side in contact with a corresponding one of the planar surfaces.

In the embodiment of FIG. 7, the ply 31′ has three flat sides, and there are thus three spacer elements 33 positioned around the circumference of the ply 31′. In alternative embodiments, depending on the form of the mandrel 29 and of the ply 31′, there could be only one or two, or more than three, spacer elements 33.

The spacer elements 33 are for example positioned so as to leave regions of the exterior surface of the ply 31′ exposed between spacer elements 33. In the example of FIG. 7, regions 34 of the ply 31′ at the curved corners of the mandrel 29 are left exposed. Such exposed regions will allow subsequent plies to contact and bond with the ply 31′.

In some embodiments, the spacer elements 33 do not extend the whole length of the mandrel 29, but have dimensions that are progressively reduced towards the thin end of the mandrel, the spacer elements 33 for example stopping between 10 and 40 cm from the end of the ply 31′.

The spacer elements 33 are, for example, made of steel, aluminum or other rigid metals or materials. In some embodiments, the spacer elements 33 are made of the same material as the mandrel 29.

In the example of FIG. 7, the spacer elements 33 are fixed in position on the structure by pins or screws 36 that fix the spacer elements 33 to the upper end of the mandrel 29. However, it would also be possible for the spacer elements 33 to be fixed in position by other means, such as by the geometry of the mandrel and of the layup, or to be only held by being captured by subsequent layers of the layup.

FIG. 8 illustrates, with a cross-section view A, a structure composed of the structure shown in FIG. 7 wrapped with the ply 35. A view B in FIG. 8 illustrates an example of the ply 35 prior to its application, which for example has a width that varies based on the tapering of the mandrel.

In one embodiment, the ply 35 is wrapped at least two times around the outer surface of the structure shown in FIG. 7.

The ply 35 is, for example, formed around the structure shown in FIG. 7 using a roll-wrapping process, or a hand-lay-up process. In alternative embodiments, the ply 35 could be a tubular braid formed by a tubular braiding process or a filament winding process.

The ply 35 has, for example, the same length as the ply 31′.

For example, in one embodiment the plies 31′ and 35 are both filament windings, and the ply 35 is formed during the same process step as ply 31′ within a filament-winding process. In such a case, the plies 31′ and 35 can be formed of a single continuous filament. For example, the ply 31′ is formed around the mandrel 29 without cutting the filament at the end of the formation of the ply 31′, the spacer elements 33 are then placed around the structure, and the ply 35 is then formed around the structure using the same filament as the ply 31′.

FIG. 9 illustrates a cross-section view of the structure shown in FIG. 8 wrapped with the ply 37.

FIG. 10 illustrates a cross-section view of the structure shown in FIG. 9 wrapped with the ply 39.

The application of each of the plies 37 and 39 is for example the same or similar to the application of the ply 35, and will not be described in detail.

The plies 37, 39 have, for example, the same length as the ply 35.

For example, the resin is add to fibers to form the fabric of each ply 31′, 35, 37, 39 through either: pre-impregnating, meaning that the fibers are impregnated with a combination of wet and/or dry resins at or near the time the material is produced; wet layup, meaning that the material comprises wet resin at the time it is positioned around the mandrel 29; or an infusion process, meaning that the resin is introduced to the material after it has been positioned around the mandrel 29, for example by placing the layup in a contained mold or compression system with a vacuum-based pull or a pressure-based push system to force the resin into the layup and the plies.

After the step of formation of the ply 39, the structure shown in FIG. 10 is for example wrapped in a compression layer, such as a compressive cellulose layer (not illustrated), and cured by heating for a period of time depending on the nature and the formulation of the resin matrix.

After the curing step, the cellulose layer is for example removed by sanding or by unwinding, and the mandrel 29 is removed from the structure. The spacer elements 33 are also removed to form the cavities 32A, 32B and 32C of FIG. 3, resulting in the shaft 151 illustrated in FIG. 3.

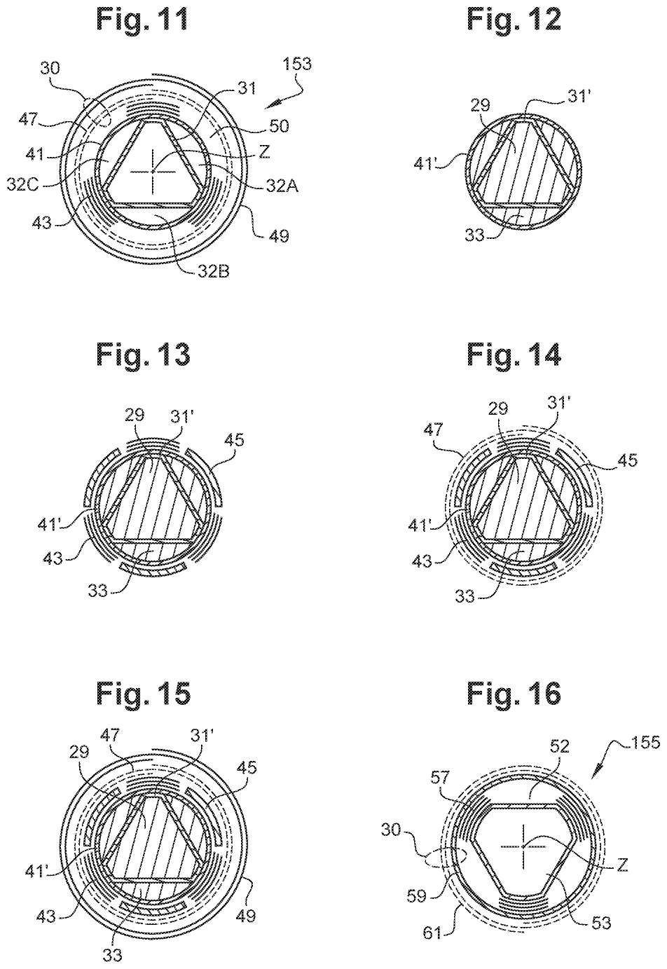

FIG. 11 is a cross-section view of a shaft 153, and corresponds for example to a cross-section of: at least a portion of the shaft 15 of the pole 11 of FIG. 1A; or of at least a portion of the lower part 15B of the shaft 15 of the pole 13 of FIG. 1B, between the locking adjuster 17 and the tip 27; or at least a portion of the upper part 15A of the shaft 15 of FIG. 1B, between the locking adjuster 17 and the grip. Moreover, FIG. 3 can correspond to a cross-section of the shaft 15 of the golf club 12 of FIG. 2A or the shaft of the oar 14 of FIG. 2B.

In the case that the shaft 153 is a shaft of the ski pole 11 or 13 of FIG. 1A or 1B, it for example has an outer dimension of between 8 mm and 30 mm, depending on where the cross-section is taken. More generally, the diameter of the shaft 153 is for example of between 5 mm and 100 mm, depending on the application.

The shaft 153 for example has the same internal wall 31 as the shaft 151 shown in FIG. 3. Furthermore, the external wall 30 of the shaft 153 is similar to the one of the shaft 151, although in the shaft 153, the external wall 30 comprises only two plies. However, the external wall 30 of the shaft 153 is for example fixed to the internal wall 31 via intermediate layers, as will now be described in more detail.

The shaft 153 for example comprises an intermediate wall 41, which is for example round in cross-section, contacting and fixed to the curved corners of the internal wall 31. Stacks 43 of tape are for example positioned at certain points around the outer surface of the intermediate wall 41, with spaces in between these stacks 43 defining further cavities 50 within the structure. The external wall 30 is for example round in cross-section, and has an inner surface that contacts each of the stacks 43, thereby rigidly fixing the external wall 30 to the internal wall 31. The external wall 30 for example comprises an inner ply 47 and an outer ply 49.

In alternative embodiments, the internal wall 31, the intermediate wall 41, and the external wall 30, could have any combination of different shapes when situated in the manner prescribed by the design of the mold and spacing system result in a shape of the external wall 30, which is substantially circular, such as an ellipse, a stadium shape or a rounded-multi-faceted shape.

In FIG. 11, the stacks of tape 43 are formed on the outer surface of the ply 41 adjacent to the contact points between the internal wall 31 and the intermediate wall 41. There is, for example, the same number of stacks of tape 43 as the number of contact points between the internal wall 31 and the intermediate wall 41. Thus, in the example of FIG. 3 based on an internal wall 31 having three flat wall portions and three corners, there are for example three stacks 43 of tape, and three cavities 50 separating the stacks 43. The stacks of tape 43 are, for example, rounded in such a manner to follow the curvature of the intermediate wall 41, meaning that the stacks of tape 43 have the shape of a circular arc in the case that the intermediate wall 41 is round.

In FIG. 11, each stack of tape 43 comprises three layers of tape, although in alternative embodiments, each stack 43 could comprise one or two layers of tape, or more than three layers of tape.

The tape forming the stacks 43 is for example a uni-directional fiber tape held in a resin matrix, such that each stack 43 forms a fiber-reinforced composite stack.

Fibers of the plies forming the internal, intermediate, and external walls 31, 41, 30, and of the tapes of the stacks 43 are, for example, chosen from the same list as the fibers of the plies of the shaft 151. In some embodiments, the fibers of the plies forming the internal, intermediate, and external walls 31, 41, 30, are all different from each other, whereas in other embodiments, there are at least two different types of fibers among the plies. In one embodiment, the fibers of at least one of the plies forming the internal, intermediate, and external walls 31, 41, 30 are natural fibers, such as organic fibers, or vegetal or vegetal-derived fibers.

Resins of fiber- or fabric-reinforced composites of the internal, intermediate and external walls 31, 41, 30, and in some cases of the stacks 43, are, for example, thermoset resins or/and thermoform resins. In some embodiments, the same resin is used for each of these composites, whereas in alternative embodiments, there are at least two different types of resin. In one embodiment, each of these composites is composed of between 20% w to 60% w of resin, for example, between 35% w to 45% w of resin.

In one embodiment, in order to provide a relatively high strength of the shaft 153, the fabric of at least one ply of the internal wall 31, the intermediate wall 41 and the external wall 30 comprises a uni-directional fabric oriented substantially in line with the Z axis of the shaft, and for example at an angle of between −5° and +5° with respect to that axis, and the fabric of at least one other ply of the internal wall 31, intermediate wall 41 and external wall 30 comprises a multi-directional fabric, and/or a bi-directional fabric having fibers in a first direction oriented with an angle of between 30° and 60°, and in some cases between 40° and 50°, with respect the axis Z, and having fibers in a second direction oriented with an angle of between −30° to −60°, and in some cases between −40° and −50°, with respect the axis Z.

In one example, a ply of the internal wall 31 is a tubular braid of bamboo fibers, a ply of the intermediate wall 41 is a tubular braid of ramie fibers, the ply 47 of the external wall 30 is a uni-directional tape of ramie fibers, and/or the ply 49 of the external wall 30 is a stitched ply of +45°/−45° bamboo fiber fabric.

In one embodiment, at least two plies of the shaft 153 have fibers oriented in different directions to each other with respect to the axis of the shaft.

In an alternative embodiment (not illustrated) to that of FIG. 11, the internal wall 31 has a circular shape and the intermediate wall 41 has a rounded-triangular shape. According to this embodiment, the cavities 32A, 32B and 32C are situated around the internal wall 31. The cavities 32A, 32B and 32C have a triangular shape in which the side closest to the internal wall is curved in a such manner to follow the shape of the internal wall 31.

In an alternative embodiment (not illustrated) to that of FIG. 11, a shaft may comprise any number of the intermediate walls 41 which is greater than one, and a corresponding plurality of cavities as is determined to be advantageous in order to optimize the mechanical characteristics of the shaft relative to the physical space available to reinforce the shaft.

FIGS. 12 to 15 comprise side views and cross-section views illustrating an example of steps of a method of manufacturing the shaft 153 illustrated in FIG. 11.

The method for example starts with the same steps as described above with reference to FIGS. 4 to 7, and these steps will not be described again in detail.

FIG. 12 illustrates, with a cross-section view, a structure composed of the structure shown of FIG. 7, wrapped with a ply 41′ for forming the intermediate wall 41.

In FIG. 12, the ply 41′ is formed around the outer surface of the structure shown in FIG. 7 using a tubular braiding process, a filament winding process, or a roll-wrapping process. The ply 41′ has, for example, the same length as the ply 31.

For example, in one embodiment the plies 31′ and 41′ are both filament windings, and the ply 41′ is formed during the same process step as ply 31′ within a filament-winding process. In such a case, the plies 31′ and 41′ can be formed of a single continuous filament. For example, the ply 31′ is formed around the mandrel 29 without cutting the filament at the end of the formation of the ply 31′, the spacer elements 33 are then placed around the structure, and the ply 41′ is then formed around the structure using the same filament as the ply 31′.

FIG. 13 illustrates, with a cross-section view, the structure shown in FIG. 12 with the addition of the stacks 43 of tape, and spacer elements 45 positioned between the stacks 43. For example, one spacer element 45 is positioned between each pair of neighboring stacks 43 around the ply 41, adjacent to the spacer elements 33.

The spacer elements 45 are for example curved in cross-section so as to match the curvature of the outer surface of the intermediate wall 41 and the curvature of the inner surface of the external wall 30 to be formed. The spacer elements 45 are, for example, made of any type of material as the material described for the spacer elements 33 described in relation with FIG. 7.

The stacks 43 of tape are, for example, formed using a hand-lay-up process. Each stack 43 for example extends the same length as the ply 41′.

The spacer elements 45 are for example of the same length as the spacer elements 33, or, for example, shorter than the spacer elements 33. The spacer elements 45 are, for example, situated in any portion of the length w2 as described in FIG. 5. For example, the spacer elements 45 are fixed or held in place in a similar manner to the spacer elements 33.

FIG. 14 illustrates, with a cross-section view, a structure composed of the structure shown in FIG. 13 wrapped with the ply 47.

In one embodiment, the ply 47 is formed of a fabric wrapped at least two times around the outer surface of the structure shown in FIG. 13. The ply 47 is, for example, formed around the structure shown in FIG. 13 using a roll-wrapping process, or a hand-lay-up process. The ply 47 has, for example, the same length as the ply 41′.

FIG. 15 illustrates, with a cross-section view, a structure composed of the structure shown in FIG. 14 wrapped with the ply 49.

The application of the ply 49 is, for example, the same or similar to the application of the ply 47, and will not be described in detail. The ply 49 has, for example, the same length as the ply 41′.

After the step of formation of the ply 49, the structure shown in FIG. 15 is for example wrapped in a compression layer, such as a compressive cellulose layer, and cured by heating.

After the curing step, the cellulose layer is for example removed by sanding or un-winding, and the mandrel 29 is removed from the structure. The spacer elements 33, 45 are also removed to form the cavities 32A, 32B and 32C, 50 of FIG. 11, resulting in the shaft 153 illustrated in FIG. 11.

FIG. 16 is a cross section view of a shaft 155, and corresponds for example to a cross-section of: at least a portion of the shaft 15 of the pole 11 of FIG. 1A; or of at least a portion of the lower part 15B of the shaft 15 of the pole 13 of FIG. 1B, between the locking adjuster 17 and the tip 27; or at least a portion of the upper part 15A of the shaft 15 of the pole 13 of FIG. 1B, between the locking adjuster 17 and the grip. Moreover, FIG. 3 can correspond to a cross-section of the shaft 15 of the golf club 12 of FIG. 2A or the shaft 15 of the oar 14 of FIG. 2B.

In the case that the shaft 155 is a shaft of the ski pole 11 or 13 of FIG. 1A or 1B, it for example has an outer dimension of between 8 mm and 30 mm, depending on where the cross-section is taken. More generally, the diameter of the shaft 155 is for example of between 5 mm and 100 mm, depending on the application.

The shaft 155 is for example similar to the shaft 153 of FIG. 11, except that there is no intermediate wall 41, and the stacks 43 of tape are replaced by stacks 57 of tape formed directly on the curved corners the internal wall 31. The internal wall 31 of FIG. 11 is replaced by an internal wall 53 having a shape that is for example adapted in consequence to have wider corners. The external wall 30 for example comprises an inner ply 59 having its inner surface in contact with the stacks 57 of tape, and an outer ply 61.

In FIG. 16, each stack 57 of tape comprises three layers of tape, although in alternative embodiments, each stack 57 could comprise one or two layers of tape, or more than three layers of tape.

The tape forming the stacks 57 is for example the same as the tape of the stacks 43 of tape of FIG. 11, and will not be described again.

Fibers of the plies forming the internal and external walls 53, 30, and of the tapes of the stacks 57 are, for example, chosen from the same list as the fibers of the plies of the shaft 151. In some embodiments, the fibers of the plies forming the internal and external walls 53, 30, are all different from each other, whereas in other embodiments, there are at least two different types of fibers among the three plies. In one embodiment, the fibers of at least one of the plies forming the internal and external walls 53, 30 are natural fibers, such as organic fibers, or vegetal or vegetal-derived fibers.

Resins of fiber- or fabric-reinforced composites of the internal and external walls 31, 30, and in some cases of the stacks 57, are, for example, thermoset resins or/and thermoform resins. In some embodiments the same resin is used for each of these composites, whereas in alternative embodiments, there are at least two different types of resin. In one embodiment, each of these composites is composed of between 20% w to 60% w of resin, for example, between 35% w to 45% w of resin.

In one embodiment, in order to provide a relatively high strength of the shaft 155, the fabrics of the plies of the internal and external walls 53, 30 are for example chosen in a similar fashion to those of the shaft 151 described above.

In one example, a ply of the internal wall 31 is a tubular braid of bamboo fiber, the ply 59 of the external wall 30 is a tubular braid of ramie fibers, and/or the ply 61 of the external wall 30 is a bamboo fiber uni-directional tape.

In one embodiment, at least two plies of the shaft 155 have fibers oriented in different directions to each other with respect to the axis of the shaft.

FIGS. 17 to 22 are cross-section views illustrating steps of a method of manufacturing the shaft 155 illustrated in FIG. 16.

FIG. 17 illustrates, with a cross-section view, a mandrel 51 used in the method. The mandrel 51 is for example similar to the mandrel 29 illustrated in FIGS. 3 and 4, except that its curved corners each occupy an angle θ larger than the corresponding angle of the mandrel 29, and for example of between 5° and 60°.

FIG. 18 illustrates, with a cross-section view, the mandrel 51 after application of a ply 53′ for forming the internal wall 53.

The ply 53′, shown in FIG. 18, is similar to the ply 31′ shown in FIG. 5, with the difference that the ply 53′ is adapted to the shape of the mandrel 51.

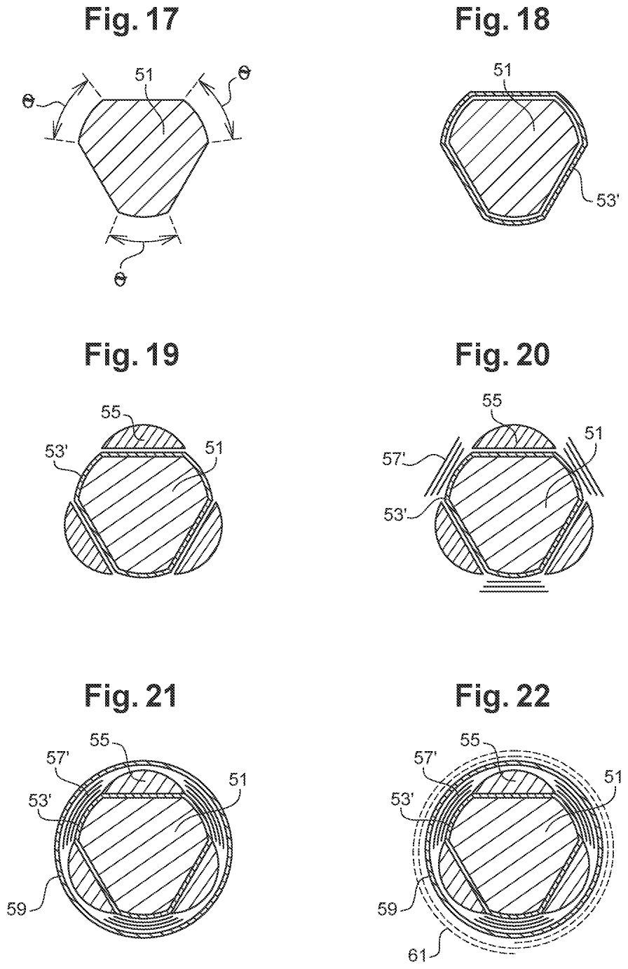

FIG. 19 illustrates, with a cross-section view, a structure composed of the structure shown in FIG. 18 with the addition of spacer elements 55. The spacer elements 55 are for similar to the spacer elements 33 illustrated in FIG. 3, except that each spacer element 55 for example has a lobular shape, and thus protrudes radially outwards by a distance that exceeds the circle defined by the three curved corners of the mandrel 51. As will become apparent from the subsequent steps, this additional protrusion is for accommodating the stacks 57 of tape.

FIG. 20 illustrates, with a cross-section view, a structure composed of the structure shown in FIG. 19 with the addition of the stacks 57′ of tape. The stacks 57′ are for example formed on the exposed rounded corners of the ply 53′, between the spacer elements 55. Each stack 57′ for example extends the same length as the ply 53′.

The stacks 57′ of tape are, for example, formed using a hand-lay-up process.

FIG. 21 illustrates, with a cross-section view, a structure composed of the structure shown in FIG. 20 wrapped with the ply 59. The ply 59 is, for example, formed all around the structure shown in FIG. 20 and in contact with each spacer element 55 and each stack 57′ of tape. The ply 59 is for example a tubular braid, and for example has the same length as the ply 53′.

FIG. 22 illustrates, with a cross-section view, a structure composed of the structure shown in FIG. 21 wrapped with the ply 61. In one embodiment, the ply 61 is wrapped at least two times around the outer surface of the structure shown in FIG. 21.

The ply 61 is, for example, formed around the structure shown in FIG. 21 using a roll-wrapping process or a hand-lay-up process. The ply 61 has, for example, the same length as the ply 53.

After the step of formation of the ply 61, the structure shown in FIG. 22 is for example wrapped in a compression layer, such as a compressive cellulose layer, and cured by heating.

After the curing step, the cellulose layer is for example removed by sanding, and the mandrel 51 is removed from the structure. The spacer elements 55 are also for example removed to form the cavities 52 of FIG. 16, resulting in the shaft 155 illustrated in FIG. 16.

According to one example embodiment, the shaft as described in the present disclosure is fabricated based on the following process:
mold is placed on a filament winding machine and a first layer of ramie and pineapple leaf fiber is wound upon the mandrel to approximate the load-distribution characteristics of a tubular braid. Spacers are added to the mandrel and the second ply of fiber is added by filament winding of extracted cellulose and pineapple leaf fiber to approximate a +45/−45 fabric. Additional spacers are added with 3 layers of unidirectional bamboo reinforcement positioned in a 0° orientation between the spacers. The final ply is added by filament winding of ramie and extracted cellulose fibers to approximate a +15/−15 biaxial fabric;
mold is placed on a filament winding machine and a first layer of ramie and pineapple leaf fiber is wound upon the mandrel to approximate the load-distribution characteristics of a tubular braid. Spacers are added with 4 layers of unidirectional bamboo reinforcement positioned in a 0° orientation between the spacers and secured in place with a ‘tacking wind’ of fiber using filament winding. The final ply is added by roll-wrapping a unidirectional ply of basalt fiber which is intermittently reinforced with spread-tow rovings of ramie fiber on its internal face at +75 or −75 orientations to the shaft;
mold is roll-wrapped with a triaxial fabric comprised of ramie, extracted cellulose, and pineapple leaf fibers. Spacers are placed and extracted cellulose and pineapple leaf fibers are filament wound upon the assembly to approximate the load-sharing characteristics of a tubular braid. The layup is completed with a multi-layer wrapping of unidirectional basalt fibers in a 0° orientation to the shaft;
mold is roll-wrapped with a triaxial fabric comprised of ramie, extracted cellulose, and pineapple leaf fibers. Spacers are placed and extracted cellulose and pineapple leaf fibers are filament wound upon the assembly to approximate the load-sharing characteristics of a tubular braid. The layup is completed with a multi-layer roll-wrapping of a triaxial fabric comprised of ramie, extracted cellulose, and pineapple leaf fibers; and
mold is roll-wrapped with a biaxial fabric comprised of basalt fibers in a 0/90 orientation. Spacers are placed and ramie, extracted cellulose and pineapple leaf fibers are filament wound upon the assembly to approximate the load-sharing characteristics of a tubular braid. Additional spacers are added with 2 layers of unidirectional bamboo reinforcement positioned in a 0° orientation between the spacers. The final ply is added by filament winding of ramie and extracted cellulose fibers to approximate a +15/−15 biaxial fabric.

An advantage of the shafts described herein is that it they a structure leading to increased strength-to-weight and/or stiffness-to-weight ratio with respect to a single-walled shaft. This for example permits natural fibers to be used in place at least some synthetic fibers.

An advantage of the use of natural fibers in the fabrics of the plies of the shaft is that it provides a shaft having a lower ecological impact with respect to shafts made entirely of synthetic materials. Indeed, the production of 1 Kg of carbon fiber is estimated to result in around 30 Kg of greenhouse gasses, whereas the use of 1 Kg of natural fibers is estimated to result in only around 0.5 Kg of greenhouse gasses, and depending on the source of the natural fibers, can even be carbon neutral or carbon negative in some cases.

A further advantage of the use of natural fibers is that, since the density of natural fibers is lower than that of synthetic fibers, a relatively light-weight shaft can be produced.

An advantage of the overlap of fabrics having a uni-directional fiber arrangement and fabrics having a multi-directional fiber arrangement is that it improves mechanical resistance to forces imparted on the shaft during use.

An advantage of providing a shaft having both an internal wall 31, 53 and an external wall 30 that have different shapes is that it optimizes the fabrication of the shaft for different use dynamics.

Various embodiments and variants have been described. Those skilled in the art will understand that certain features of these embodiments can be combined and other variants will readily occur to those skilled in the art. For example, while embodiments have been described in which the curing of the shaft is performed under pressure exerted by an external compression cellulose layer, it will be apparent to those skilled in the art that alternative processes could be used, such as the use of a rigid external mold into which the layup is placed, and the use of an expandable bladder in place of the mandrel, the expandable bladder having a form significantly similar to that of the mandrel.

1. A shaft for athletic activities comprising, along at least a part of the length of the shaft:
an internal wall made of a first fiber-reinforced composite, the internal wall comprising a plurality of planar wall portions; and
an external wall, fixed to the internal wall, and made of a second fiber-reinforced composite, wherein one or more cavities are present between the internal wall and the external wall.

2. The shaft according to claim 1, wherein the one or more cavities includes at least three cavities between the internal wall and the external wall.

3. The shaft according to claim 1, wherein one or more of the first fiber-reinforced composite or the second fiber-reinforced composite includes natural fibers.

4. The shaft according to claim 1, wherein one or more of the first fiber-reinforced composite or the second fiber-reinforced composite includes vegetal-based fibers including one or more of bamboo, flax, ramie, pineapple leaf, extracted cellulose, or nanocellulose.

5. The shaft according to claim 1, wherein the first fiber-reinforced composite and the second fiber-reinforced composite each have a weight percentage of resin between 20% and 60%.

6. The shaft according to claim 1, wherein one or more of the first fiber-reinforced composite or the second fiber-reinforced composite is a fabric-reinforced composite.

7. The shaft according to claim 1, wherein one or more of the internal wall or the external wall includes a filament wound ply.

8. The shaft according to claim 1, wherein at least one of the first fiber-reinforced composite or the second fiber-reinforced composite comprises one or more of a fabric, a filament-wound ply, or a braid having fibers at an orientation angle between 30° and 60° or between −30° and −60° with respect to an axis of the shaft.

9. The shaft according to claim 1, wherein at least one of the first fiber-reinforced composite or the second fiber-reinforced composite comprises one or more of a fabric, a tape, or a filament-wound ply having fibers at an orientation angle between −15° and 15° with respect to an axis of the shaft.

10. The shaft according to claim 1, wherein the external wall is round or substantially round in cross-section.

11. The shaft according to claim 1, wherein the internal wall is tubular.

12. The shaft according to any of claim 1, wherein the plurality of planar wall portions of the internal wall are linked by curved corners.

13. The shaft according to claim 1, wherein fibers of the external wall are orientated in one or more first directions with respect to an axis of the shaft, and fibers of the internal wall are orientated in one or more second directions different to the one or more first directions with respect to the axis of the shaft.

14. A method of manufacturing a shaft, the method comprising:
covering one of a mandrel or an inflatable bladder with at least one first ply, wherein the at least one first ply is impregnated with a first resin;
fixing at least one spacer element to an outer surface of the at least one first ply to form a structure having one or more exposed regions in its outer surface;
covering the structure with at least one second ply, wherein the at least one second ply is impregnated with a second resin;
curing to cause the at least one first ply and the first resin to form an internal wall of a first fiber-reinforced composite and the at least one second ply and the second resin to form an external wall of a second fiber-reinforced composite, wherein the internal wall comprises a plurality of planar wall portions; and
removing the at least one spacer element to create one or more cavities between the internal wall and the external wall.

15. The method of claim 14, wherein the outer surface of the structure is round or substantially round in cross-section, and covering the structure with at least one second ply involves use of roll-wrapping.

16. The shaft according to claim 1, wherein the first fiber-reinforced composite and the second fiber-reinforced composite each have a weight percentage of resin between 35% and 45%.
